(19) United States
(12) Patent Application Publication
(10) Pub. No.: US 2013/0228945 A1
(43) Pub. Date: Sep. 5, 2013

(54) METHOD AND ASSEMBLY FOR MANUFACTURING INGESTIBLE PRODUCTS

(71) Applicant: Peter B. Franklin, North Falmouth, MA (US)

(72) Inventor: Peter B. Franklin, North Falmouth, MA (US)

(21) Appl. No.: 12/452,032

(22) PCT Filed: Jun. 13, 2008
(86) PCT No.: PCT/US08/07455

§ 371 Date: Sep. 18, 2012

Related U.S. Application Data
(63) Continuation-in-part of application No. 61/072,204, filed on Mar. 28, 2008.
Application No. 61/072,204 is a continuation-in-part of application No. 61/124,091, filed on Apr. 14, 2008.
(60) Provisional application No. 60/934,362, filed on Jun. 13, 2007.
(60) Provisional application No. 60/993,467, filed on Sep. 12, 2007.
(60) Provisional application No. 60/998,209, filed on Oct. 9, 2007.

(51) Int. Cl. A23P 1/02

(52) U.S. Cl. CPC A23P 1/027
USPC 264/28

(57) ABSTRACT

A method and assembly for manufacturing ingestible products from liquids and soft-solid ingestible matters, the method including the steps of hard freezing the liquid or soft-solid ingestible matter, granulating the hard-frozen ingestible matter, and thereafter either (1) placing the hard-frozen granules in a mold and molding a single hard-frozen product, or (2) drying the granules and packaging same for subsequent molding or transporting or use.

### CROSS-REFERENCE TO RELATED APPLICATIONS

This application claims priority from U.S. Provisional Patent Application 60/934,362, filed Jun. 13, 2007; U.S. Provisional Patent Application 60/993,467, filed Sep. 12, 2007; U.S. Provisional Patent Application 60/998,209, filed Oct. 9, 2007; U.S. Provisional Patent Application 61/072,204, filed Mar. 28, 2008; and U.S. Provisional Patent Application 61/124,091, filed Apr. 14, 2008, all in the name of Peter B. Franklin, and all incorporated herein by reference.

### BACKGROUND OF THE INVENTION

1. Field of the invention

The invention relates to the manufacture of ingestible products, such as foodstuffs, pharmaceuticals, and nutraceuticals, and more particularly, to methods and assemblies for manufacturing such products where the manufacturing of the product requires freezing the ingestible products to a hard, frozen solid state prior to additional processing.

2. Description of the Prior Art

In the production of certain foods, pharmaceuticals, and nutraceutical products (hereinafter ingestible products), processing of the product is undertaken and then the processed product is frozen as a means to harden and/or preserve the product for storage and transport. Traditionally, in food processing, little, if anything, is done in the way of further processing after the product is frozen. The product is usually simply warmed for serving or is served frozen (as is the case in ice cream type products).

An example of such a product is ice cream. Ice cream is fully formed and processed when the ice cream is soft, prior to freezing. The ice cream is produced, pumped into molds, extruders, or containers when soft, then hard-frozen for storage and transport.

Because ice cream is processed when it is soft, many shapes are not possible inasmuch as the soft ice cream flattens when it is extruded onto a plate, and can only be extruded into a tapered mold to allow extraction when frozen. A stick may have to be inserted into the product to assist with extraction from the mold.

In addition, because freezing is a slow process and it occurs at the end of the ice cream manufacturing process, overall production speeds are slowed to accommodate the slow freezing manufacturing bottleneck at the end of the line.

Thus, traditional preparation of frozen products, for example ice cream or frozen drinks, involves processing a liquid or a soft solid, i.e., unfrozen material, and freezing at the end of the process. Freezing is merely employed as a mechanism to harden and preserve products for storage and transport, with most processing occurring prior to freezing. Upon arrival at a destination, the hard-frozen product is simply warmed and served or the product is served frozen; the entity receiving the frozen product does not normally further process the frozen product in its frozen state.

Further, molding in the frozen dessert industry is limited because water expands up to 9% when frozen, pressurizing molds and making the mold release difficult if not impossible in most circumstances. Frozen dessert manufacturers have addressed this problem by using special molds and processes which limit the shapes and sizes of these desserts. For example, stick molding is a process in which soft ice cream, i.e., ice cream at about 20° F. or greater, is poured into tapered stainless steel molds, a stick is inserted and the stick, mold, and product are frozen. The mold and product are then warmed slightly to release the product from the mold, and the stick is used to pull the ice cream out of the mold. This process restricts the possible shapes because it requires the end product to have a stick to assist with releasing the product from the mold, at least one flat side where filling occurs, and a tapered shape to facilitate withdrawal from the mold.

Another known process is bar molding, in which soft ice cream is poured from a vertical pipe. The soft ice cream is extruded from the pipe to the thickness desired, and then a wire, or the like, is used to cut the soft ice cream, which is then deposited as a shaped soft body of ice cream onto a cold plate for freezing. This process requires the product to have flat tops and bottoms where the wire cuts the ice cream. Further, the ice cream height is limited, inasmuch as the sides of the product are inclined to “slump” prior to freezing solid if the product is too thick. Also, the process is relatively slow to accommodate the slow freezing time at the end of process, running at speeds of approximately thirty to sixty pieces per minute for a single lane.

A further problem in the frozen dessert industry is that frozen hard ice cream is impossible to pump and difficult to scoop. To overcome these difficulties, soft serve machines have been devised to make small batches of soft ice cream that can be pumped and easily dispensed at a location where it is consumed, however, making ice cream usually requires a government permit, subjecting local retail operators to strict ice cream sanitation and government regulations. This involves frequent government inspections and requires a lengthy dismantling and sanitation process each week. Further, these small-batch ice cream manufacturing devices are complex and expensive.

In beverages containing fruit or produce, freezing has been used simply to extend product life, such as with frozen concentrated fruit juices. Further, fruit and produce used in drinks is usually transformed into a puree to make a drink concentrate or for inclusion in a fresh made drink. Pureeing fruit or produce into a liquid rapidly deteriorates the color and nutritional value through oxidation. Further, concentrated fruit puree is traditionally frozen as a solid block that is slow to melt and dissolve. To prepare a drink with fruit and/or produce, ingredients typically require the use of a blender or other mechanical device to pulverize the fruit or produce, which involves both setting up the device and a post process cleaning step. Still further, frozen concentrate typically is sold as a bulk product, generally unavailable in single serving sizes. Further, frozen fruit and produce are available only in large pieces, which are not suitable for inclusion in the production of foods or beverages requiring small particle size.

There is thus a need to provide a method and assembly for manufacturing ice cream and other frozen ingestible food products, using a processing method which is operable at high speeds and can produce new shapes and forms, including three-dimensional shapes with no flat side, and no need for a stick extending from the product. There is further a need to provide a method for making beverages or other foods with fruit, dairy products and produce which:

uses ingredients that are already in small pieces or granules, so no blender or mechanical pulverizing or blending is required during final preparation.

maintains more of the natural nutritional value of the ingredients, and

does not need additives (artificial or natural) for coloring.

### SUMMARY OF THE INVENTION

Accordingly, an object of this invention is to provide a new method and assembly for manufacturing ingestible products from liquids and soft-solid ingestible products, such as ice cream, custard, yogurt, fruit, produce, pharmaceuticals, nutraceuticals, and other soft-solid ingestible products, that uses freezing as an essential process prior to additional processing.

A further object is to provide a frozen, granulated or powdered food which does not turn brown, does not otherwise lose its natural color, which minimizes the loss of nutrients, and which does not turn into a liquid state prior to the formation of small pieces or granules, and which is susceptible to molding and/or mixing with a selected liquid.

A further object of the invention is to provide a method for molding a hard-frozen body of ingestible matter into the configuration of a small cylinder, an oblate spheroid or any 3D shape.

With the above and other objectives in view, a feature of the present invention is the provision of a method for forming a hard solid ingestible product from an ingestible liquid or soft-solid matter, the method including the step of hard freezing the liquid or soft-solid ingestible matter, and thereafter processing the hard-frozen ingestible product, as by any one or more of granulating, grinding, milling, grating, slicing and chopping to provide discrete small pieces of hard-frozen granules. The granules can then be placed into a three-dimensional mold and compressed into a single hard-frozen solid. Tablet forming equipment, for instance, could be used to mold and compress the granules into a tablet shape.

In accordance with a still further feature of the invention, there is provided a method for molding a cylindrically-shaped round frozen body of ingestible matter into the configuration of an oblate spheroid or other three dimensional shape.

The above and other features of the invention, including various novel details of method steps, production assemblies, and combinations thereof, will now be more particularly described with reference to the drawings and pointed out in the claims. It will be understood that the particular method steps and assemblies embodying the invention are shown and described by way of illustration only and not as limitations of the invention. The principles and features of this invention may be employed in various and numerous embodiments without departing from the scope of the invention.

### BRIEF DESCRIPTION OF THE DRAWINGS

Reference is made to the accompanying drawings in which are shown illustrative embodiments of the invention, from which its novel features and advantages will be apparent.

In the drawings:

FIGS. 1-7 are flow charts illustrating embodiments of inventive methods for manufacturing hard-frozen ingestible products;

FIG. 8 is a diagrammatic illustration of a method for molding a particularly-shaped hard-frozen ingestible product; and

FIGS. 9-12 are block diagrams, each illustrative of one form of an assembly for forming hard-frozen ingestible products.

### DESCRIPTION OF THE PREFERRED EMBODIMENTS

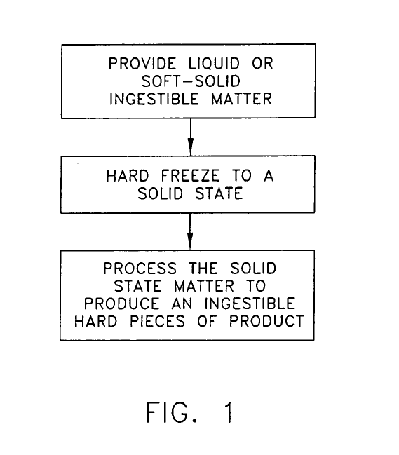

Referring to FIG. 1, it will be seen that the inventive process is initiated by providing liquid or soft-solid ingestible matter, such as a food product, a pharmaceutical product, or a nutraceutical product, or a combination thereof, and hard freezing the product to a solid state.

As used herein, “ingestible” is intended to mean suitable to be ingested, as by eating or drinking. “Hard-frozen” is intended to mean a solid frozen state. “Soft solid” is intended to mean semifrozen, or “soft-serve”, or “slushy”, or “compressable”, “squeezable” including dairy products, fruit, produce and the like.

The soft-solid ingestible matter may be ice cream, yogurt, fruit, produce, and the like, which generally contains some liquid by volume. The liquid is generally water, a dairy liquid, fruit juice, or a combination thereof.

After hard-freezing the product, it is subjected to a process which is undertaken on the product while the product remains in the hard-frozen state.

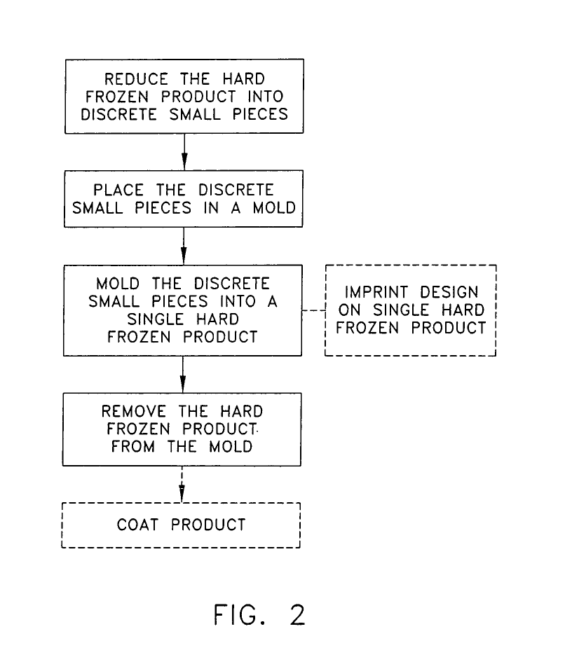

Referring to FIG. 2, it will be seen that the processing of the hard-frozen ingestible product includes reducing the hard-frozen product into discrete small pieces. The reduction of the hard-frozen product may be accomplished by grinding, milling, granulating, grating, slicing, chopping, and the like, to provide the discrete small pieces, which are preferably, but not necessarily, generally uniform in shape and size. The reducing of the hard-frozen product may be repeated. For instance, slicing prior to grinding may be required to achieve desired small pieces in size and shape.

A selected quantity of the discrete small pieces is placed in a mold which preferably has been pre-cooled. The mold is operated to compress the small pieces into a molded single, solid, shaped product. As an example, a tableting machine could be used for this purpose. Inasmuch as the product has been frozen prior to grinding, or the like, there is no expansion or pressurization caused by the product, the discrete small pieces move easily to fill all cavities in the mold. The molded product is then removed from the mold, as by mechanical pressure or compressed air ejection.

The mold may be provided with interior means for imparting a design, such as a logo or name onto the surface of the single solid product.

Optionally, the solid product may be coated with a selected coating of ingestible matter, such as chocolate and/or a sugar based coating. Further the process of coating the product may include panning.

The discrete small pieces can be placed in the mold in such a manner as to constitute a layer of the molded product. Two or more layers can be placed in the mold, one upon another, to provide for molding a hard-frozen product of two or more layers, each layer having a selected characteristic, such as flavor and/or color, and the like. Layers of different foods can be selected to add to the hard-frozen product, such as one or more layers of fruit, nuts, chocolate, creams, cake-like foods, and such.

The mold may be provided with means for release of air from the interior thereof during the molding process.

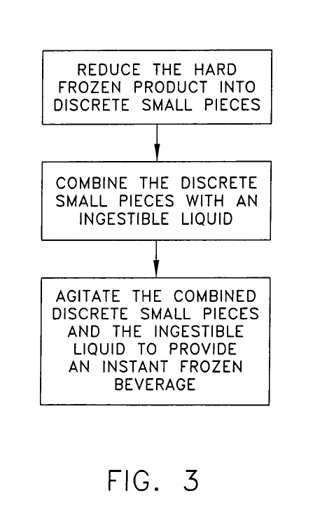

In another embodiment, shown in FIG. 3, the hard-frozen product is reduced to discrete small pieces. Because the discrete small pieces are of different sizes and frozen solid, micro air channels between the small pieces are retained during shipping and storage, reducing or eliminating the “clumping” together of the discrete small pieces. The small frozen pieces may be combined with an ingestible liquid and the mixture agitated to provide an “instant” frozen beverage.

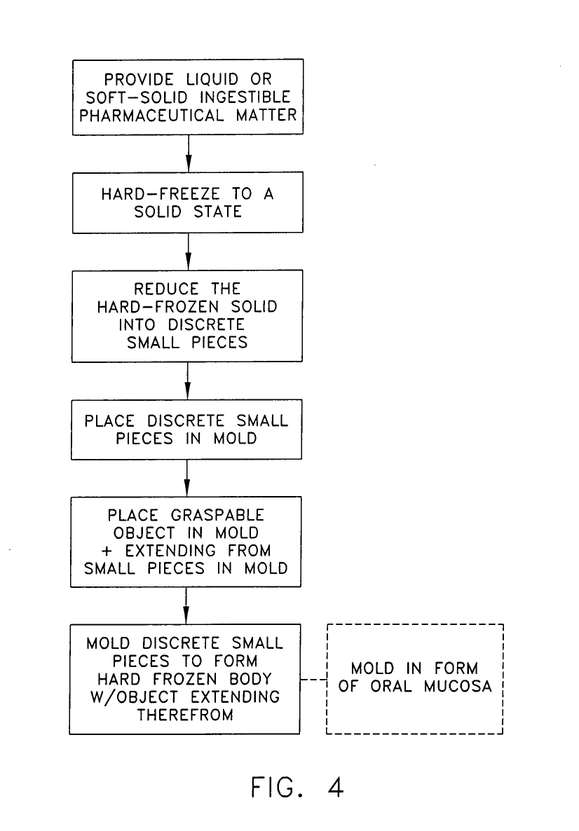

In a further preferred embodiment (shown in FIG. 4), the ingestible matter comprises a pharmaceutical matter and the processing thereof, after hard freezing to a solid state, includes reducing the hard-frozen state matter into discrete small pieces and molding the small pieces into a single hard-frozen ingestible pharmaceutical item adapted for placement in the mouth of a user. In this embodiment, the item may be molded in the shape of a frozen tablet for ease of dispensing and rapid dissolution in the mouth. For certain drugs, it is often helpful to mold the item onto a stick or other graspable projection, by which the item may be manipulated by the user to place it against the oral mucosa and taste bud areas in the mouth. By contact with the oral mucosa, the drug will be absorbed through the oral mucosa, bypassing the liver. Further, by contacting the taste buds with a cold delivery vehicle, taste is depressed, making easier acceptance of poor tasting pharmaceuticals.

Preferably, the item adapted for placement in the mouth of a user is molded to generally conform to the oral mucosa of a human (FIG. 4; dashed lines).

The provision of a drug delivered and stored as a frozen product provides the additional benefit of dramatically reducing diversion and counterfeiting of the drug. The product must remain frozen to maintain its shape and effectiveness.

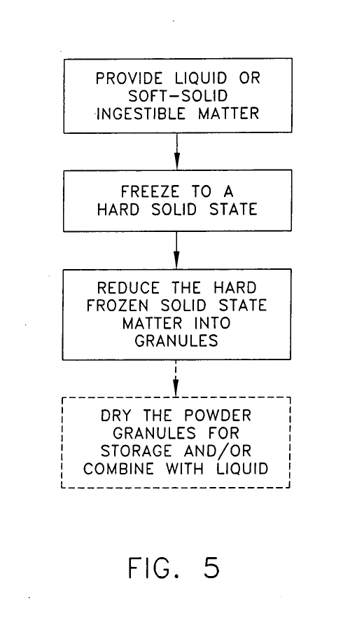

Referring to FIG. 5, it will be seen that in an alternative embodiment of the invention, after the soft-solid or liquid ingestible matter is hard-frozen, it is reduced to frozen granules. The granules are then dried and may be stored for subsequent use, or combined with liquid to provide a drink. When the granules are frozen fruit, because they have not entered a liquid state prior to drying and the drying process is so rapid, they maintain much of their natural color and nutritional value. Accordingly, when used with fruit, the present method provides the added benefit of improving nutritional value and appearance of drinks.

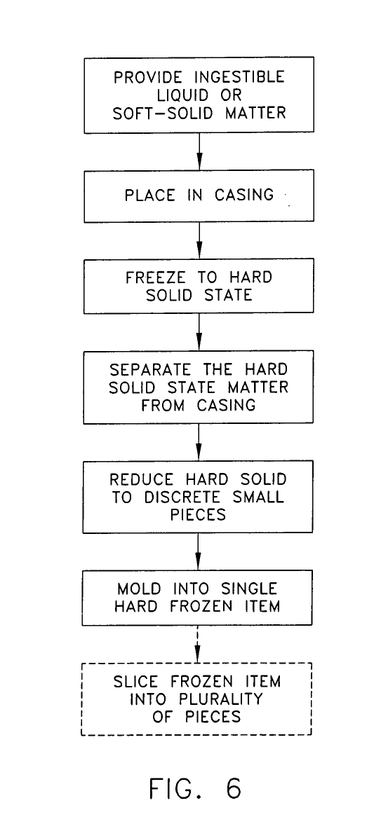

In a further embodiment of the invention (FIG. 6), ingestible liquid or soft-solid matter is placed in a casing and hard-frozen and stored until needed. The casing may be plastic or an all-natural material, such as cellulose. Subsequently, the casing is separated from the hard-frozen matter. The hard-frozen matter may be reduced to hard-frozen discrete small pieces. The small pieces may then be molded to form a single hard-frozen item. Optionally, the hard-frozen matter may be sliced, or otherwise divided into a plurality of pieces.

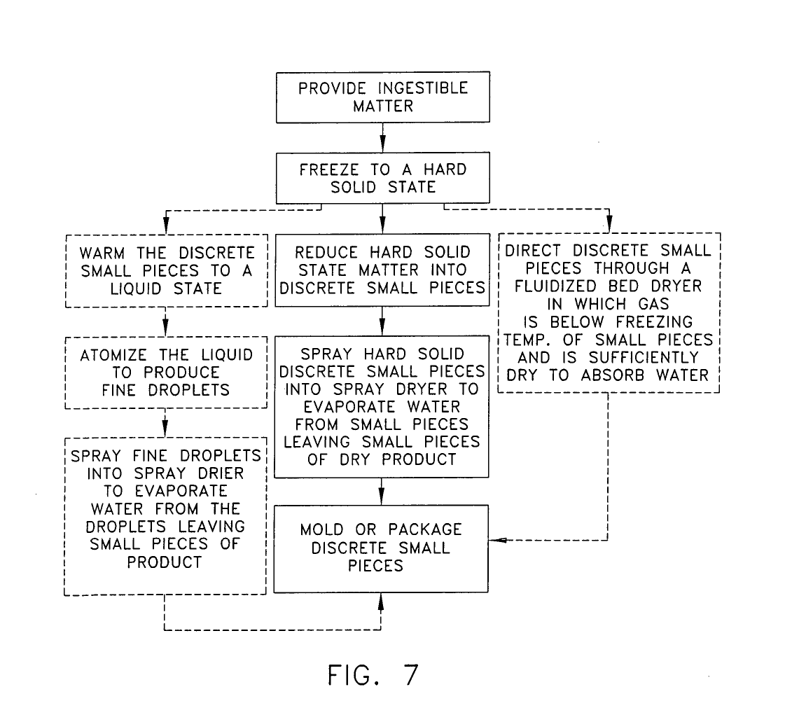

Referring to FIG. 7, it will be seen that further options may be exercised as to processing of the hard-frozen discrete small pieces:

(1) the hard-frozen discrete small pieces may be sprayed into a spray dryer to evaporate any water in the small pieces, leaving substantially dry small pieces;

(2) the hard-frozen discrete small pieces may be warmed to in part a liquid state and atomized to produce fine droplets. Thereafter, the fine droplets are sprayed into a spray dryer to evaporate the water from the droplets, leaving substantially dry pieces;

(3) the hard-frozen discrete small pieces may be directed though a fluidized bed dryer in which gas is sufficiently warm and/or dry to eliminate the water from the small pieces, leaving substantially dry small pieces.

Thereafter, in all three cases the small pieces are molded or packaged, either at the location of the dryer, or at any remote location.

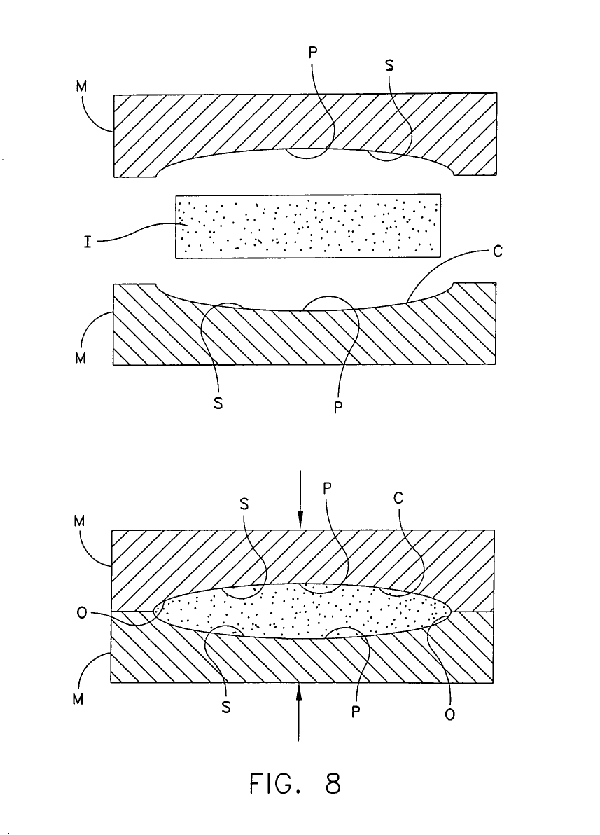

Referring to FIG. 8, to produce a product such as an oblate-spheroid shape, processing preferably includes:

using a mold M having a cavity C of an oblate spheroid configuration and opposed curved surfaces opposed from each other at their midpoint P.

placing a solid, frozen ingestible matter in the bottom portion of the mold in cavity C. The thickness or height of the solid, frozen ingestible matter is greater than the distance between the midpoint P of the upper mold and the midpoint P of the bottom mold when fully compressed. The matter will preferably not extend beyond the outer edges of the mold O. The total volume of the matter is sufficient to substantially form the oblate spheroid when compressed, with minimal or no overflow. The shape of the ingestible material is preferably a tablet shape, or a small “pile” of frozen granules.

closing the mold so the outer edges of the mold M touch and such that compression of the ingestible matter I by the molds curved surfaces compress the matter I to cause the matter to expand radially outward in the mold to engage outer portion O of the mold cavity C and compress to the selected thickness. The matter I preferably fills the mold cavity, to produce a molded item of an oblate-spheroid configuration and of substantially uniform consistency throughout.

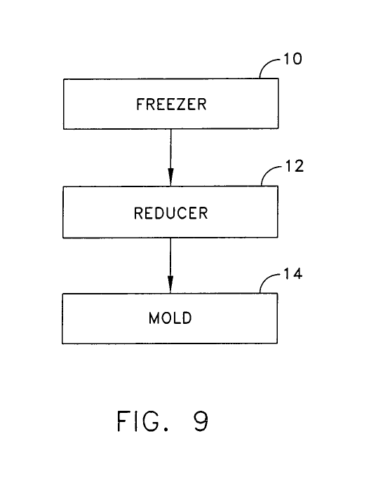

As is illustrated in FIG. 9, the basic components required for practicing the hereinbefore described methods are a freezer 10 for forming the hard-frozen ingestible product, a reducer 12 for reducing the hard-frozen product to discrete small hard-frozen pieces, and a mold 14 in which the small hard-frozen pieces are compressed into a single hard-frozen final product. As noted immediately above, the mold may be located proximate to the reducer or at a remote location.

The reducer 12 may be adapted to grind, mill, grate, slice, chop or granulate the hard-frozen body exiting the freezer 10, the object being merely to reduce the hard-frozen body into a multitude of small discrete hard-frozen pieces.

The mold 14 is adapted to compress the discrete small pieces into a hard-frozen single product of selected size and form. The mold is not limited to having a flat surface or a tapered configuration.

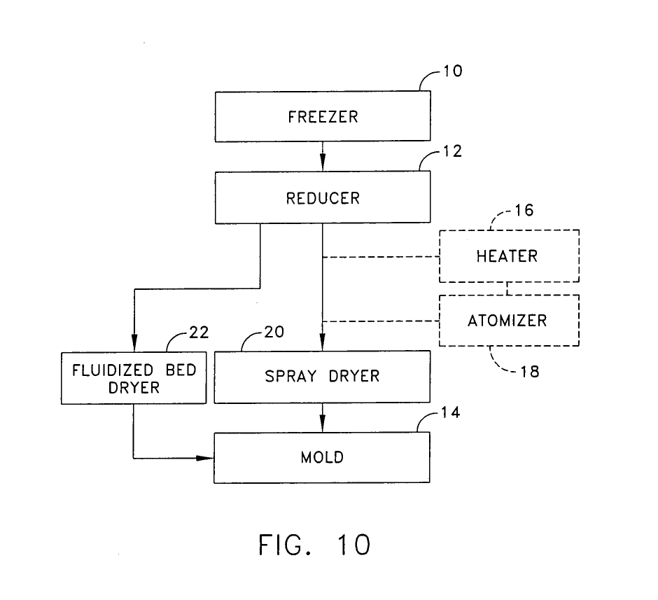

As shown in FIG. 10, and described hereinabove, after the reducer 12 has broken the hard-frozen product down to hard-frozen discrete small pieces, the small pieces may be warmed by a heater 16 to convert the hard-frozen small pieces to liquid in part, and then atomized in an atomizer 18 to produce fine liquid droplets which are put into a spray dryer 20 in which the water is evaporated, leaving small pieces of dry product. This dry product may be packaged or molded into a single form prior to packaging.

Alternatively, the reduced hard-frozen product may be passed though a fluidized bed dryer 22 and thence packaged or passed into the mold 14 prior to packaging.

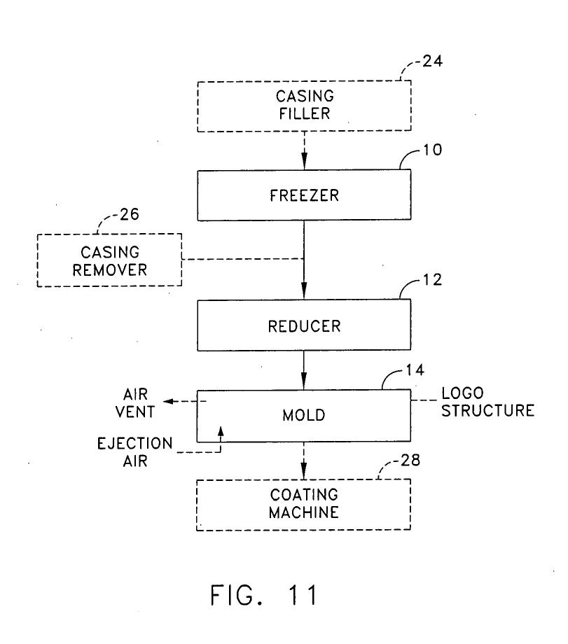

In FIG. 11, there is shown an assembly of the basic three components, the freezer 10, the reducer 12, and the mold 14. In addition, there are shown optional further devices to facilitate the method described hereinabove, in which the initial ingestible product is disposed in a casing. In this embodiment, there is provided a casing filler 24 and a casing remover 26.

The mold 14, as mentioned hereinabove, may be provided with an air vent, an air inlet (ejector), a mechanical ejector and/or a logo-forming structure.

If it is desired to coat the final product, a coating machine 28 may be provided.

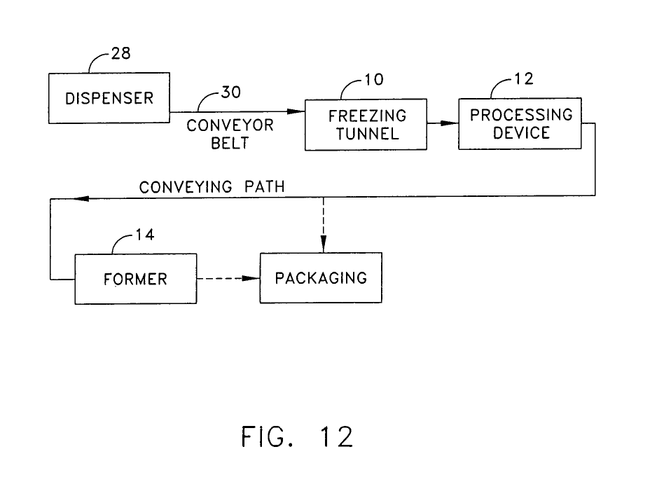

In FIG. 12, there are illustrated the components of an assembly of the type that would find utility in a relatively high-output facility.

Ingestible matter is dispensed from a dispenser 28 by way of a conveyor belt 30 which passes through a freezing tunnel 10 which serves to hard-freeze the ingestible matter, and thence to a processing device 12, which serves to turn the hard-frozen ingestible matter into small discrete hard-frozen pieces. The small pieces are conveyed to a packaging device or former, mold 14, for the molding of a single hard-frozen ingestible product prior to packaging.

There are thus provided methods for manufacturing ingestible products, and assemblies for effecting those methods. The assemblies utilize machines and devices that are known and available commercially but in most cases need to be adapted to the specific requirements of these processes. These changes include adjusting machine tolerances, belt material, lubricating greases and other moving parts to operate at frozen temperatures. Grinding, slicing, and granulating blades need to be adjusted for the hardness of each ingestible material when frozen. Further, optimal freezing temperatures for grinding, granulating, slicing and otherwise reducing will vary depending on the fiber content of the ingestible matter and the size of the granules desired. However, the basic machine functionality will remain unchanged, and it is believed that the particular arrangement of the machines and devices, to effect the novel methods, provide a novel and heretofore unknown solution to long-standing problems.

It will be understood that many changes in the details, materials, steps and arrangement of parts, which have been herein described and illustrated in order to explain the nature of the invention, may be made by those skilled in the art within the principles and scope of the invention as expressed in the appended claims.

What is claimed is:

1. A method for manufacturing a hard-frozen ingestible product from a selected one of ingestible liquid matter and/or ingestible soft-solid matter, the method comprising the steps of:
freezing the selected ingestible matter to a hard solid frozen state; and
processing the hard solid frozen state matter to produce the hard-frozen ingestible product.

2. The method in accordance with claim 1, wherein the ingestible liquid matter and the ingestible soft-solid matter comprise, respectively, liquid food and liquid pharmaceutical/nutraceutical matter and soft-solid food and soft-solid pharmaceutical/nutraceutical matter.

3. The method in accordance with claim 2, wherein the soft-solid food comprises a selected one of custard, fruit, produce, yogurt, soft ice cream and other dairy products.

4. The method in accordance with claim 2, wherein the liquid comprises water, at least in part.

5. The method in accordance with claim 2, wherein the liquid comprises fruit juice, at least in part.

6. The method in accordance with claim 1, wherein the ingestible liquid matter and soft-solid ingestible matter is placed in a casing prior to freezing to the hard solid state.

7. The method in accordance with claim 1, wherein the processing of the hard solid state frozen matter comprises reducing the hard solid state frozen matter into hard-frozen discrete small pieces or granules.

8. The method in accordance with claim 7, wherein the hard-frozen discrete small pieces or granules are of at least one of different sizes and different shapes.

9. The method in accordance with claim 7, wherein the reducing of the hard solid state frozen matter comprises at least one of grinding, milling, grating, slicing, chopping and granulating.

10. The method in accordance with claim 7, wherein the processing further comprises placing the discrete small pieces in a mold, and molding of the small pieces into a single hard-frozen ingestible product item.

11. The method in accordance with claim 10, wherein the mold is cooled prior to molding.

12. The method in accordance with Claim. 10, wherein the discrete small pieces are layered in the mold with layers of other discrete small pieces of selected ingestibles.

13. The method in accordance with claim 12, wherein the discrete small pieces are layered in the mold with other layers of foods selected from dairy products, fruits, produce, nuts, chocolate, creams and cake-like foods.

14. The method in accordance with claim 10, wherein the molding comprises compression to compress the small pieces into a single solid shape.

15. The method in accordance with claim 14, wherein air is released from the mold during the molding.

16. The method in accordance with claim 10, wherein the mold is provided with an interior structure to impart a selected design on the hard-frozen ingestible matter.

17. The method in accordance with claim 10 comprising the further step of ejecting the single hard-frozen ingestible item from the mold.

18. The method in accordance with claim 17 comprising the further step of coating the single hard-frozen ingestible item with water based coatings, chocolate, or sugar based coatings, using panning, sprayers, waterfalls or other standard coating processes.

19. The method in accordance with claim 10 comprising the further step of ejecting the single hard-frozen item into engagement with another ingestible item to form an ingestible product of a plurality of ingestible components.

20. The method in accordance with claim 6 comprising the further step of removing the casing from the hard solid state ingestible matter, reducing the hard solid state matter into discrete small pieces, introducing the discrete small pieces into a mold, and molding the small pieces into a single hard-frozen ingestible product item.

21. The method in accordance with claim 6, wherein the casing is ruptureable by application of a manual pressure to permit manual squeezing of the hard-frozen ingestible product from the casing.

22. The method in accordance with claim 6, comprising the further steps of removing the casing from the hard solid state ingestible matter, and reducing the hard solid state matter by slicing the solid state matter into a plurality of pieces.

23. The method in accordance with claim 7, and further comprising the steps of combining the solid state frozen matter small pieces with a selected ingestible liquid, and agitating the combination to provide a generally instant frozen beverage.

24. The method in accordance with claim 2, wherein the ingestible matter comprises a pharmaceutical matter, and the processing thereof comprises reducing the hard solid state frozen matter into discrete small pieces and molding the small pieces into a single hard-frozen ingestible pharmaceutical item adapted to be placed in the mouth of a user.

25. The method in accordance with claim 24, wherein the single hard-frozen ingestible pharmaceutical item is molded onto a graspable projection by which the item is manipulable by the user.

26. The method in accordance with claim 25, wherein the hard-frozen ingestible pharmaceutical item is molded to generally conform to an oral mucosa of a human.

27. The method in accordance with claim 7, wherein the discrete small pieces comprise powder granules for at least one of storage, subsequent combining with a selected liquid, consumption and molding.

28. The method in accordance with claim 7, wherein the step of processing the hard solid state frozen matter comprises spraying the frozen small pieces into a spray dryer for rapid evaporation of water therein.

29. The method in accordance with claim 7, wherein the step of processing the hard solid state frozen matter comprises the additional steps of warming the discrete small pieces to a liquid state in part, atomizing the liquid to produce fine droplets and spraying the fine droplets into a spray dryer.

30. The method in accordance with claim 7, wherein the step of processing the hard solid state frozen matter comprises a selected one of (1) running the discrete small pieces through a fluidized bed dryer in which gas therein is sufficiently dry to absorb water taken from the discrete small pieces, and (2) warming the discrete small pieces to evaporate water from the discrete small pieces.

31. A method for forming a hard-frozen ingestible product from a selected one of ingestible liquid matter and ingestible soft-solid matter, the method comprising the steps of hard freezing the selected ingestible matter and processing the hard-frozen ingestible product, the processing comprising at least a selected one of grinding, milling, grating, granulating, slicing and chopping the hard-frozen ingestible product to provide hard-frozen granules, placing the granules in a mold, and compressing the granules into a single solid of a selected three dimensional shape.

32. An assembly for forming a hard-frozen ingestible product from a liquid or soft solid ingestible matter, the assembly comprising:
a conveying belt moveable along a conveying path;
a dispenser adapted to dispense the ingestible matter onto said belt;
a freezing tunnel in communication with said belt and adapted to receive and hard freeze the ingestible matter to produce a hard-frozen product; and
a processing device disposed after said freezing tunnel and in communication with said belt apparatus and adapted to generate small discrete hard-frozen pieces of the ingestible matter.

33. The method in accordance with claim 17, wherein the step of ejecting the single hard-frozen item from the mold comprises ejection by compressed air or mechanical pressure.

34. A method for forming a molded ingestible product of an oblate-spheroid configuration and having a substantially constant consistency throughout, the method comprising the steps of:
hard-freezing an ingestible product
reducing the ingestible product into hard-frozen discrete small pieces or granules.
Forming a tablet or creating a pile from the small pieces or granules
provide a mold having a cavity in an oblate spheroid configuration and
opposed surfaces spaced from each other at their midpoints, when the mold is closed, by a distance smaller than the thickness or height of the ingestible matter; and
compressing the ingestible matter with the mold opposed curved surfaces to cause the matter to expand radially outwardly in the mold cavity to engage outer portions of the mold cavity and completely fill the mold cavity; to thereby produce a molded item of an oblate spheroid configuration and of substantially uniform consistency throughout.

35. A method of manipulating a dairy product, fruit, vegetable, produce, or any combination thereof, the method comprising the steps of:
under conditions in which the dairy product, fruit, vegetable, produce, or any combination thereof is frozen, processing the frozen dairy product, fruit, vegetable, produce, or any combination thereof to generate frozen pieces of the frozen dairy product, fruit, vegetable, produce, or any combination thereof; and
packaging at least some of the frozen pieces for transportation or sale in the frozen state.

36. The method of claim 35 further comprising the step of freezing the dairy product, fruit, vegetable, produce, or any combination thereof, prior to the processing step.

37. The method of claim 35 wherein the dairy product comprises ice cream or yogurt.

38. The method of creating a three dimensional edible item, the method comprising the steps of:
under conditions in which a dairy product, fruit, vegetable, produce , or any combination thereof is frozen, processing the frozen dairy product, fruit, vegetable, produce, or any combination thereof to generate frozen pieces of the frozen dairy product, fruit, vegetable, produce or any combination thereof, and
under conditions in which the frozen pieces are kept frozen, placing at least a portion of the frozen pieces into a mold and molding them into the three-dimensional edible item.

39. The method of claim 38 further comprising the step of freezing the dairy product, fruit, vegetable, produce or any combination thereof, prior to the processing step.

40. The method of claim 38 wherein the dairy product comprises ice cream or yogurt.

41. The method of claim 38 wherein the placing step further includes placing a second substance into the mold with at least some the frozen pieces and molding the pieces and the second substance together into the three-dimensional edible item.

42. The method of claim 41 wherein the second substance comprises a pharmaceutical or nutraceutical product.

43. A plurality of frozen edible pieces packaged for transportation or sale in the frozen state, the plurality of frozen edible pieces being created by processing a dairy product, fruit, vegetable, produce or any combination thereof, under conditions in which the dairy product, fruit, vegetable, produce or a combination thereof is frozen.

44. A method for forming an ingestible product from a selected one of ingestible liquid matter and ingestible soft-solid matter, the ingestible comprising the steps of hard freezing the selected ingestible matter and processing the hard-frozen ingestible product, the processing comprising at least a selected one of grinding, milling, grating, granulating, slicing and chopping the hard-frozen ingestible product to provide hard frozen granules, drying the granules, and subjecting the dry granules to a selected one of (1) molding to form a single ingestible product and (2) packaging for transportation or sale.
